(19) United States
(12) Patent Application Publication
(10) Pub. No.: US 2025/0133442 A1
(43) Pub. Date: Apr. 24, 2025

(54) WIRELESS COMMUNICATION SYSTEM, WIRELESS COMMUNICATION METHOD, NETWORK CONTROLLER, AND NETWORK CONTROL PROGRAM

(71) Applicant: NIPPON TELEGRAPH AND TELEPHONE CORPORATION, Tokyo (JP)

(72) Inventors: Hisayoshi KANO, Musashino-shi, Tokyo (JP); Munehiro MATSUI, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 18/682,454

(22) PCT Filed: Aug. 18, 2021
(86) PCT No.: PCT/JP2021/030245

§ 371 Date: Feb. 9, 2024

(51) Int. Cl. H04W 28/02

(52) U.S. Cl. CPC H04W 28/0289; H04W 28/0236

(57) ABSTRACT

A wireless communication system of the present disclosure is configured to establish a low delay communication path by linking node stations of a first group among a plurality of node stations constituting a wireless network. Further, the wireless communication system is configured to establish a high delay communication path by linking node stations of a second group among the plurality of node stations and at least one node station of the first group. The wireless communication system of the present disclosure transmits all traffic using the low delay communication path until the low delay communication path enters a congestion state, and transmits traffic having a long allowable delay time among all the traffic using the low delay communication path and the high delay communication path together upon receiving detection of a congestion state of the low delay communication path.

### TECHNICAL FIELD

The present invention relates to a wireless communication system, a wireless communication method, a network controller, and a network control program.

### BACKGROUND ART

In recent years, mobile communication systems have developed, and thus mobile services can now be enjoyed on most of the Earth's surface. Super-coverage is one requirement in fifth generation (Beyond 5G) or sixth generation mobile communication systems expected to be commercialized in the future. Super-coverage involves expanding service areas to places where installation costs of existing base stations are high or base stations are difficult to be installed, such as mountains, the sea, the air, and the like. In addition, it is also necessary to strengthen the country against natural disasters and the like, and it is desired to develop communication systems which are robust against ground disasters.

As a means for realizing the above requirements, non-terrestrial networks (NTNs) are receiving attention. An NTN is a wireless network using node stations deployed in the air or space such as satellites, unmanned aerial vehicles (UAV), high altitude pseudo-satellites (HAPS), and drones. In an NTN, node stations connect communication links to each other to form a network and are further connected to a mobile network on the ground via a ground base station.

In an NTN, a node station has a mobile base station function. A traffic packet generated from a terminal station is transferred to a node station connected to a ground base station using a routing function and sent to the Internet. The same processing is performed using the routing function for a packet from the Internet network to the terminal station.

At the time of performing routing in an NTN, a node station, a terminal station, and a ground base station select a path having a minimum propagation time to a traffic transmission destination. When a communication path passing through a low altitude node station is compared with a communication path passing through a high altitude node station, a propagation delay of the communication path passing through the low altitude node station is shorter to the extent that its distance from the ground is shorter. Therefore, traffic tends to concentrate on the communication path passing through the low altitude node station. However, concentration of traffic causes congestion, resulting in a communication delay, packet loss, and throughput decrease due to buffer overflow.

NPL 1 discloses a method of avoiding congestion for solving the above-described problems in an NTN. The method of avoiding congestion proposed in NPL 1 (hereinafter referred to as a conventional method) can be described using FIG. 14.

In an NTN, a communication path RL passing through low altitude node stations 7-1, 7-2, and 7-3 (hereinafter referred to as a low altitude route) and a communication path RH passing through a high altitude node station 8 (hereinafter referred to as a low altitude route) are used as communication paths from a terminal station 4 to ground base stations 3-1 and 3-2. In the low altitude route RL, traffic passes through many node stations before reaching the ground base station 3-1. Therefore, there is a high possibility of a plurality of traffic flows sharing a node station, and congestion is likely to be caused in the node station.

In the conventional method disclosed in NPL 1, a threshold value is set for a propagation time, it is determined that a transmission destination is far if the propagation time is equal to or greater than the threshold value, and it is determined that the transmission destination is near if the propagation time is less than the threshold value.

Communication is performed by selecting the high altitude route RH as a traffic communication path if it is determined that the transmission destination is far and selecting the low altitude route RL as a traffic communication path if it is determined that the transmission destination is near.

However, in the conventional method, the congestion state of the high altitude route RH is not considered at the time of determining a communication path. Therefore, the high altitude route RH is congested while the low altitude route RL has a sufficient propagation capacity depending on a traffic occurrence situation. In such a situation, the throughput of the entire system is reduced.

The above-described problem will be described using FIG. 15. The horizontal axis of the graph shown in FIG. 15 indicates a traffic transmission rate of a terminal station and the vertical axis indicates a total throughput. Here, it is assumed that a high altitude route has a propagation capacity of 5 Mbps and a low altitude route has a propagation capacity of 10 Mbps. In the example shown in FIG. 15, when the traffic transmission rate of the terminal station is 0.5 Mbps or more, congestion occurs in the high altitude route, and thus the throughput reaches the peak. On the other hand, the low altitude route has a sufficient propagation capacity. That is, the conventional method cannot sufficiently utilize the propagation capacity of the entire system.

### CITATION LIST

### Non Patent Literature

[NPL 1] Tada Yuta, Hiroki Nishiyama, Naoko Yoshimura, Nei Kato, “A study on Efficient Route Control Method for Two-layered Satellite Networks,” Technical Report, IEICE, September 2010, pp. 45-50

### SUMMARY OF INVENTION

### Technical Problem

The present disclosure has been made in view of the above circumstances, and an object of the present disclosure is to provide a technique capable of preventing occurrence of a communication delay in an NTN and reduction in throughput of an entire system while satisfying QoS requirements of traffic.

### Solution to Problem

To accomplish the aforementioned object, the present disclosure provides a wireless communication system. A wireless communication system of the present disclosure is a wireless communication system configured to establish a low delay communication path by linking node stations of a first group among a plurality of node stations constituting a wireless network and to establish a high delay communication path by linking node stations of a second group among the plurality of node stations and at least one node station of the first group. The wireless communication system of the present disclosure is configured to: transmit all traffic using the low delay communication path until the low delay communication path enters a congestion state; and transmit traffic having a long allowable delay time among all the traffic by using the low delay communication path and the high delay communication path together upon receiving detection of a congestion state of the low delay communication path.

Furthermore, to accomplish the aforementioned object, the present disclosure provides a wireless communication method. A wireless communication method of the present disclosure is a wireless communication method for establishing a low delay communication path by linking node stations of a first group among a plurality of node stations constituting a wireless network and establishing a high delay communication path by linking node stations of a second group among the plurality of node stations and at least one node station of the first group. The wireless communication method of the present disclosure includes: transmitting all traffic using the low delay communication path until the low delay communication path enters a congestion state; and transmitting traffic having a long allowable delay time among all the traffic by using the low delay communication path and the high delay communication path together upon receiving detection of a congestion state of the low delay communication path.

Furthermore, to accomplish the aforementioned object, the present disclosure provides a network controller. The network controller of the present disclosure is a network controller for controlling a wireless network composed of a plurality of node stations. The network controller of the present disclosure is configured to: establish a low delay communication path by linking node stations of a first group among the plurality of node stations; and establish a high delay communication path by linking node stations of a second group among the plurality of node stations and at least one node station of the first group. Further, the network controller of the present disclosure is configured to: transmit all traffic using the low delay communication path until the low delay communication path enters a congestion state; and transmit traffic having a long allowable delay time among all the traffic by using the low delay communication path and the high delay communication path together upon receiving detection of a congestion state of the low delay communication path.

Furthermore, to accomplish the aforementioned object, the present disclosure provides a network control program. The network control program of the present disclosure includes a program for causing a computer to execute processing performed by the network controller. That is, the network controller can be realized by the computer and the network control program. The network control program may be recorded on a computer-readable recording medium or may be provided via a network.

### Advantageous Effects of Invention

According to the technique of the present disclosure, it is possible to avoid a congestion state and to prevent occurrence of a communication delay in an NTN and reduction in throughput of an entire system while satisfying QoS requirements of traffic.

### BRIEF DESCRIPTION OF DRAWINGS

FIG. 1 is a diagram illustrating a configuration of a wireless communication system according to a first embodiment of the present disclosure and a normal communication path.

FIG. 2 is a diagram illustrating the configuration of the communication system according to the first embodiment of the present disclosure and a communication path in which a congestion state has been detected.

FIG. 3 is a diagram illustrating a configuration of a node station-mounted communication device according to the first embodiment of the present disclosure.

FIG. 4 is a diagram illustrating a configuration of a network controller according to the first embodiment of the present disclosure.

FIG. 5 is a flowchart illustrating operations of the node station and the network controller according to the first embodiment of the present disclosure.

FIG. 6 is a diagram illustrating a relationship between a transmission rate and a throughput of the entire system according to an example of the wireless communication system according to the first embodiment of the present disclosure.

FIG. 7 is a diagram illustrating a configuration of a wireless communication system according to a second embodiment of the present disclosure and a normal communication path.

FIG. 8 is a diagram illustrating the configuration of the wireless communication system according to the second embodiment of the present disclosure and a communication path in which a congestion state has been detected.

FIG. 9 is a flowchart illustrating operations of a node station and a network controller according to the second embodiment of the present disclosure.

FIG. 10 is a diagram illustrating a configuration of a wireless communication system according to a third embodiment of the present disclosure and a normal communication path.

FIG. 11 is a diagram illustrating the configuration of the wireless communication system according to the third embodiment of the present disclosure and a communication path in which a congestion state has been detected.

FIG. 12 is a diagram illustrating a configuration of a wireless communication system according to a fourth embodiment of the present disclosure and a normal communication path.

FIG. 13 is a diagram illustrating the configuration of the wireless communication system according to the fourth embodiment of the present disclosure and a communication path in which a congestion state has been detected.

FIG. 14 is a diagram for describing a conventional method of avoiding congestion.

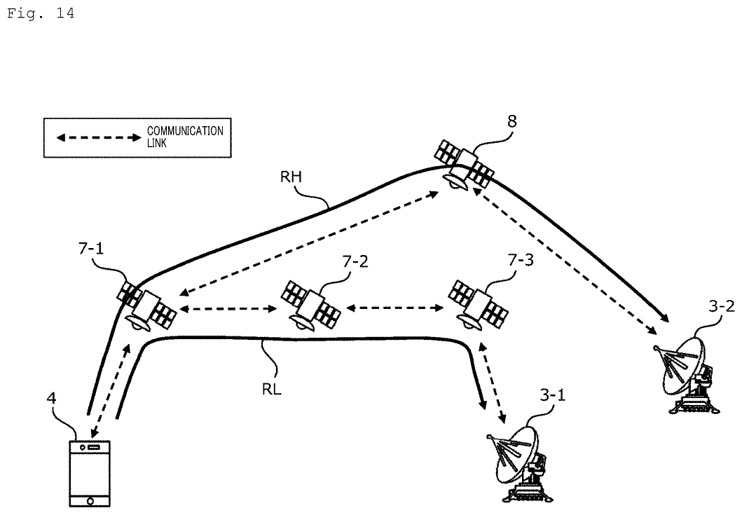

FIG. 15 is a diagram for describing problems in the conventional method of avoiding congestion.

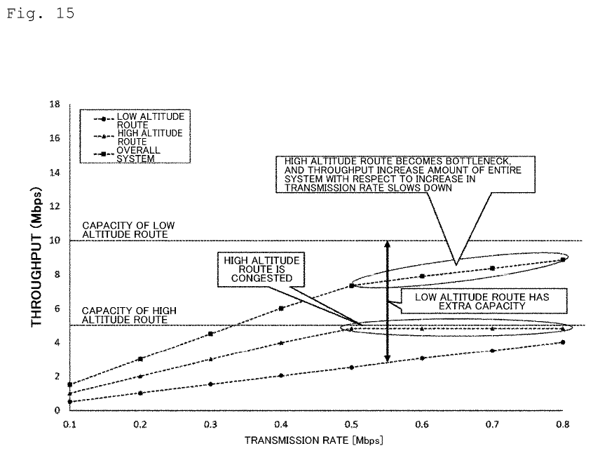

### DESCRIPTION OF EMBODIMENTS

Hereinafter, embodiments of a wireless communication system, a wireless communication method, a network controller, and a network control program of the present disclosure will be described with reference to the drawings.

### 1. First Embodiment

### 1-1. Configuration of Wireless Communication System

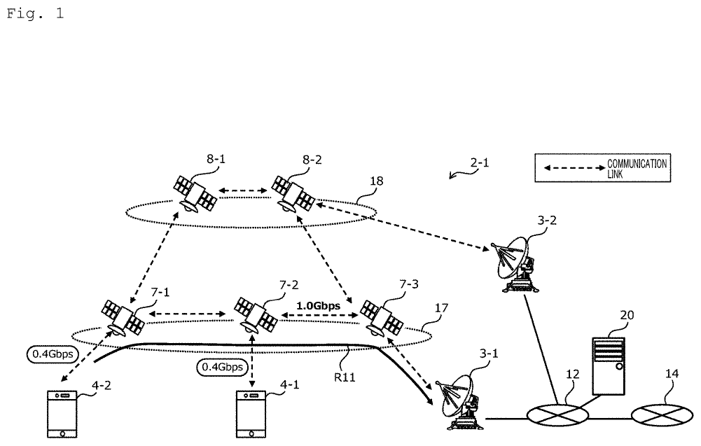

First, a configuration of a wireless communication system according to a first embodiment will be described using FIG. 1. As shown in FIG. 1, a wireless communication system 2-1 according to the present embodiment includes two types of networks 17 and 18 which are deployed in the sky and have different altitudes.

The first network is a low altitude network 17 formed by connecting node stations 7-1, 7-2, and 7-3 of a first group deployed at a relatively low altitude through a communication link. Hereinafter, the node stations of the first group constituting the low altitude network 17 are referred to as low altitude node stations. The second network is a high altitude network 18 formed by connecting node stations 8-1 and 8-2 of a second group deployed at a relatively high altitude through a communication link. Hereinafter, the node stations of the second group constituting the high altitude network 18 are referred to as high altitude node stations.

As node stations, a drone, an unmanned aerial vehicle (UAV), and an aircraft can be used in addition to a geostationary satellite (GEO), a middle orbit satellite (MEO), a low orbit satellite (LEO), and a high altitude pseudo-satellite (HAPS). Among these, node stations having relatively low altitudes are used as the low altitude node stations 7-1 to 7-3, and node stations having relatively high altitudes are used as the high altitude node stations 8-1 to 8-2. In the present embodiment, the low altitude node stations 7-1 to 7-3 are LEOs, and the low altitude network 17 is an LEO network. The high altitude node stations 8-1 to 8-2 are GEOs, and the high altitude network 18 is a GEO network. The number of node stations in each of the networks 17 and 18 shown in FIG. 1 is an example.

Whether a network is at a low altitude or at a high altitude is relative. Accordingly, a certain network may be a low altitude network in one embodiment and may be a high altitude network in another embodiment. The same applies to node stations, and a certain node station may be a low altitude node station in one embodiment and may be a high altitude node station in another embodiment. For example, the LEO network 17 used as a low altitude network in the present embodiment is used as a high altitude network in a second embodiment and is used as a medium altitude network in a third embodiment.

The low altitude network 17 is linked to a ground base station 3-1 and connected to a mobile network 12 via the ground base station 3-1. Similarly, the high altitude network 18 is linked to a ground base station 3-2 and connected to the mobile network 12 via the ground base station 3-2. Further, a communication link can be constructed between a node station belonging to the low altitude network 17 and a node station belonging to the high altitude network 18. The two networks 17 and 18 are combined by link connection to form a non-terrestrial wireless network, that is, an NTN. Any node station constituting the wireless communication system 2-1 is connected to a mobile network 20 via the NTN.

Each node station has a routing function. Each node station transmits a packet to a destination by transferring the packet between node stations. Further, each node station has a mobile base station function. A terminal station connects to any node station and connects to the mobile network 12 via the NTN. The Internet 14 can be connected via the mobile network 12. In the example shown in FIG. 1, a terminal station 4-1 is connected to the low altitude node station 7-2, and a terminal station 4-2 is connected to the low altitude node station 7-1. The functions of the node stations will be described in detail below.

A network controller 20 is connected to the mobile network 12. The network controller 20 performs monitoring of a congestion state of node stations, control of communication paths, control of link connections between node stations, and the like. The functions of the network controller 20 will be described in detail below.

In the configuration of the wireless communication system 2-1 described above, a communication link between node stations may be realized by wireless communication using radio waves or by other wireless communication such as optical communication. Further, each communication link in the wireless communication system 2-1 includes a communication line and a control line.

Although the wireless communication system 2-1 forms the NTN by combining two types of networks of different altitudes, it is also possible to form an NTN by combining three kinds of networks of different altitude.

### 1-2. Control of Communication Path

The wireless communication system 2-1 determines an end-to-end communication path while considering a congestion state of a network and QoS requirements of traffic. FIG. 1 shows an example of normally used communication paths. When the low altitude network 17 and the high altitude network 18 are compared, a propagation time to a destination is usually shorter in the low altitude network 17 having a shorter distance from the ground to a node station. Therefore, in basic settings, the low altitude route R11 is determined as a communication path such that it passes through only the low altitude network 17. For example, the traffic of the terminal station 4-2 is received by the nearest low altitude node station 7-1 and transmitted from the low altitude node station 7-1 to the ground base station 3-1 via the low altitude network 17.

However, since the low altitude network 17 also utilizes other terminal stations, traffic tends to concentrate. For example, in the example shown in FIG. 1, the traffic from the terminal station 4-1 is also transmitted to the low altitude route R11 simultaneously with the traffic from the terminal station 4-2. Here, it is assumed that the transmission capacity of the communication link of the low altitude network 17 is 1.0 Gbs. As in the example shown in FIG. 1, if the traffic amount from each of the terminal stations 4-1 and 4-2 is 0.4 Gbps, the total traffic amount of the low altitude node station 7-2 is within 1.0 Gbs which is the transmission capacity of the communication link.

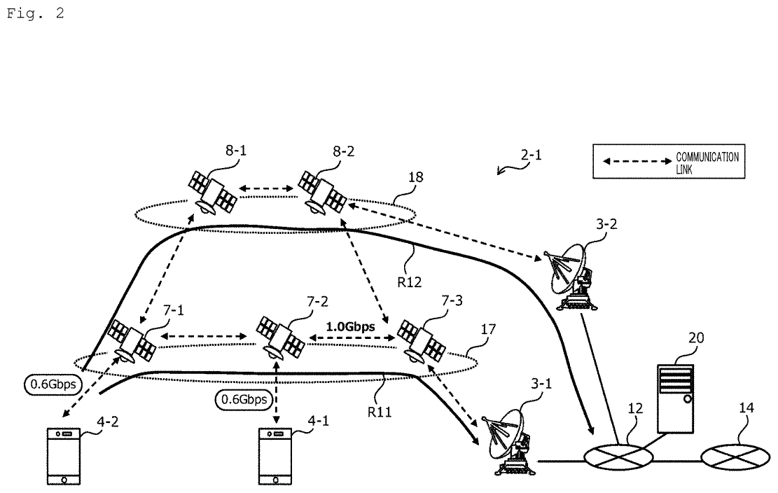

However, as in the example shown in FIG. 2, when the traffic amount from each of the terminal stations 4-1 and 4-2 is 0.6 Gbps, the total traffic amount of the low altitude node station 7-2 is 1.2 Gbps and thus exceeds 1.0 Gbs which is the transmission capacity of the communication link. As a result, the low altitude node station 7-2 enters a congestion state.

The wireless communication system 2-1 uses the high altitude network 18 together when a congestion state in the low altitude route R11 has been detected. That is, traffic is transmitted using the high altitude route R12 passing through the high altitude network 18 in addition to the low altitude route R11 passing through the low altitude network 17. However, the low altitude route R11 is a communication path with a relatively low delay, whereas the high altitude route R12 is a communication path with a relatively high delay.

In consideration of the fact that the high altitude route R12 is a high delay communication path, the wireless communication system 2-1 transmits only traffic having a long allowable delay time among all traffic, specifically, only non-real-time traffic by using the high altitude route R12 together. Non-real-time traffic transmitted using the high altitude route R12 is minimum traffic capable of canceling the congestion state of the low altitude route R11 which is a communication path with a relatively low delay.

Here, a congestion state will be described. Each node station has a transmission buffer and stores packets waiting for transmission in the transmission buffer. A congestion state can be detected using the use rate of the transmission buffer. Further, the congestion state can also be detected by observing any of the number of packet losses in each node station, the amount of packets waiting for transmission, and the amount of traffic flowing into within a predetermined time.

In the present embodiment, the congestion state is detected using the use rate of the transmission buffer. If the use rate of the transmission buffer is defined by the following formula, the congestion state can be defined as a state in which the use rate of the transmission buffer exceeds a threshold value a.

$$Transmission buffer use rate = \frac{Total packet size stored in transmission buffer [ byte ]}{Transmission buffer size [ byte ]} \qquad [ Math . 1 ]$$

According to the above definition of the congestion state, if the transmission buffer use rates of all the low altitude node stations 7-1 to 7-3 are less than the threshold value a, the wireless communication system 2-1 determines that the low altitude route R11 is not in a congestion state. Then, the wireless communication system 2-1 transmits all traffic by using only the low altitude route R11 according to the determination result.

On the other hand, when the transmission buffer use rate of any of the low altitude node stations 7-1 to 7-3 is equal to or greater than the threshold value a, the wireless communication system 2-1 determines that the low altitude route R11 is in a congestion state. Then, the wireless communication system 2-1 transmits non-real-time traffic exceeding the threshold value a by using the high altitude route R12 according to the determination result. Non-real-time traffic within the threshold value a is transmitted along with real-time traffic by using the low altitude route R11.

The non-real-time traffic has an allowable delay time longer than the real-time traffic. Therefore, the influence of transmission of some non-real-time traffic by using the high altitude route R12 with a relatively high delay is curbed low. The influence of congestion that occurs due to transmission of all traffic using the low altitude route R11 on QoS is more serious.

As described above, the wireless communication system 2-1 transmits non-real-time traffic by using the high altitude route R12 together when a congestion state has been detected in the low altitude route R11. Accordingly, it is possible to avoid the occurrence of congestion in the low altitude route R11 and prevent the occurrence of communication delay in the NTN and reduction in the throughput of the entire system while satisfying QoS requirements of traffic.

### 1-3. Configuration of Node Station

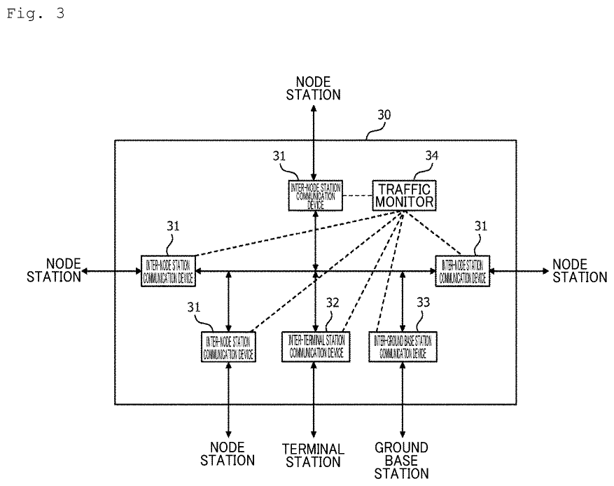

Next, a configuration of a node station for realizing the above-described communication path control by the wireless communication system 2-1 will be described. Each node station includes the low altitude node stations 7-1 to 7-3 and the high altitude node stations 8-1 to 8-2 and is provided with a node station-mounted communication device 30 having a configuration shown in FIG. 3. Further, the node station-mounted communication device 30 is also provided in node stations of the second to fourth embodiments which will be described later.

The node station-mounted communication device 30 includes an inter-node station communication device 31, an inter-terminal station communication device 32, an inter-ground base station communication device 33, and a traffic monitor 34. The inter-node station communication device 31 communicates with an adjacent node station by connecting a communication link to the node station. The inter-terminal station communication device 32 communicates with a terminal station by connecting a communication link to the terminal station. The inter-ground base station communication device 33 communicates with a ground base station by connecting a communication link to the ground base station. The traffic monitor 34 observes the amount of traffic flowing into the host device.

The node station-mounted communication device 30 notifies the network controller 20 of traffic amount information obtained by the traffic monitor 34. The notification of the traffic amount information to the network controller 20 performed by the node station-mounted communication device 30 may be periodic notification or autonomous notification performed upon occurrence of congestion.

Each of the devices 31, 32, 33, 34 provided in the node station-mounted communication device 30 may be partially or wholly constituted by hardware such as a programmable logic device (PLD) or a field programmable gate array (FPGA). Further, the function of each of the devices 31, 32, 33, 34 can be realized by a computer-executable program. The program can be recorded on a recording medium or provided through a network.

### 1-4. Configuration of Network Controller

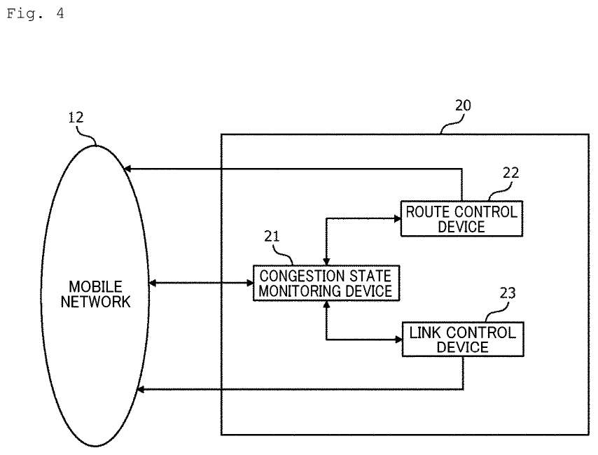

Next, a configuration of the network controller 20 for realizing the above-described communication path control by the wireless communication system 2-1 will be described with reference to FIG. 4. The network controller 20 shown in FIG. 4 has a configuration common to network controllers of the second to fourth embodiments which will be described later.

The network controller 20 includes a congestion state monitoring device 21, a route control device 22, and a link control device 23. The congestion state monitoring device 21 aggregates traffic amount information observed by each node station and determines a congestion state for each node station. As described above, a congestion state is determined according to whether or not a use rate of a transmission buffer exceeds the threshold value a. The installation place of the congestion state monitoring device 21 is not limited to the network controller 20. The congestion state monitoring device may be provided for each node station, and the network controller 20 may collect a congestion state determination result for each node station.

The route control device 22 determines an end-to-end communication path for transmitting traffic. The determination result of the congestion state monitoring device 21 is used to determine the communication path. Specifically, until a congestion state is detected, the low altitude route R11 is determined as a communication path for all traffic. Then, upon receiving detection of a congestion state, the high altitude route R12 is determined as a communication path for some non-real-time traffic.

The link control device 23 performs processing of reconstructing a communication link in the NTN on the basis of the determination result of the congestion state monitoring device 21. Specifically, upon receiving detection of a congestion state, a communication link is constructed between a node station belonging to the low altitude network 17 and a node station belonging to the high altitude network 18 such that the high altitude route R12 is established in addition to the low altitude route R11. However, in the present embodiment, communication links necessary for establishing the high altitude route R12 are constructed in advance between the low altitude node station 7-1 and the high altitude node station 8-2 (and between the low altitude node station 7-3 and the high altitude node station 8-2), as shown in FIGS. 1 and 2.

The network controller 20 can be configured as a computer including a memory storing a program and a processor coupled to the memory, for example. The functions of the respective devices 21, 22 and 23 are realized by the processor executing the program. The program can be recorded on a recording medium or provided through a network.

### 1-5. Operations of Node Station and Network Controller

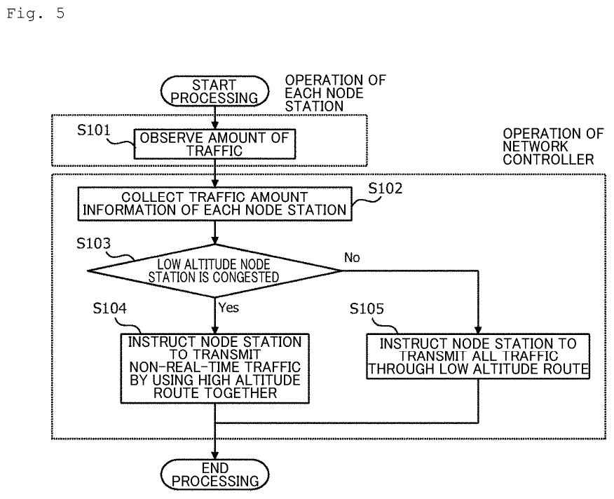

Operations of each node station and the network controller 20 having the above-described configurations will be described with reference to the flowchart of FIG. 5. The operation shown in the flowchart corresponds to the wireless communication method of the present disclosure executed by the wireless communication system 2-1.

Step S101 is the operation of each node station, more specifically, the operation executed by the node station-mounted communication device 30. In step S101, the node station-mounted communication device 30 of each node station observes the amount of traffic flowing into the host device by the traffic monitor 34.

Steps S102 to S104 are operations executed by the network controller 20. In step S102, the network controller 20 collects information on the amount of traffic observed in each node station. In step S103, it is determined whether any of the low altitude node stations 7-1 to 7-3 is in a congestion state on the basis of the collected information on the amount of traffic.

If none of the low altitude node stations 7-1 to 7-3 is in a congestion state, step S105 is selected. In step S105, the network controller 20 instructs each node station to transmit all traffic through the low altitude route R11 which is a low delay communication path.

If any of the low altitude node stations 7-1 to 7-3 is in a congestion state, step S104 is selected. In step S104, the network controller 20 instructs each node station to transmit only non-real-time traffic among all traffic by using the high altitude route R12 which is a high delay communication path together.

By operating each node station and the network controller 20 in accordance with the above-mentioned flowchart, a congestion state can be avoided and the occurrence of communication delay in the NTN and reduction in the throughput of the entire system can be prevented.

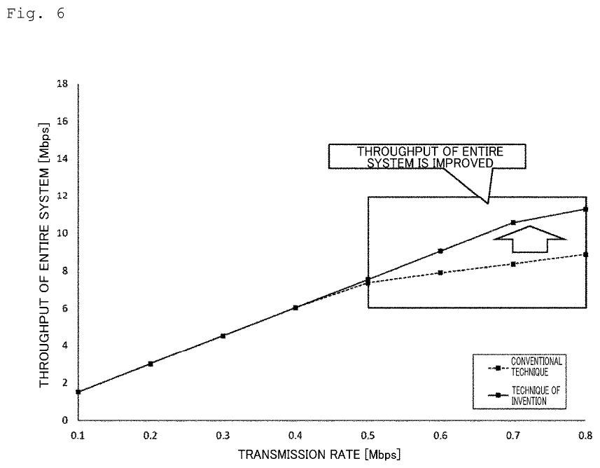

Here, evaluation results of one example of the wireless communication system 2-1 will be described. In the example, an LEO is deployed as a low altitude node station, a GEO is deployed as a high altitude node station, and the threshold value a for determining a congestion state is set to 0.7. When non-real-time traffic exceeding the propagation capacity of the low altitude route is to be transmitted using the low altitude route, a packet loss due to buffer overflow occurs in the low altitude node station. In order to avoid this, results of improving the throughput of the entire system by appropriately setting the threshold value a to control the amount of non-real-time traffic communicating through the low altitude route is shown in FIG. 6. FIG. 6 shows a relationship between a transmission rate and the throughput of the entire system according to the example. In FIG. 6, the conventional technique means use of only a low altitude route, and the present invention means an example of the wireless communication system 2-1.

### 2. Second Embodiment

### 2-1. Configuration of Wireless Communication System

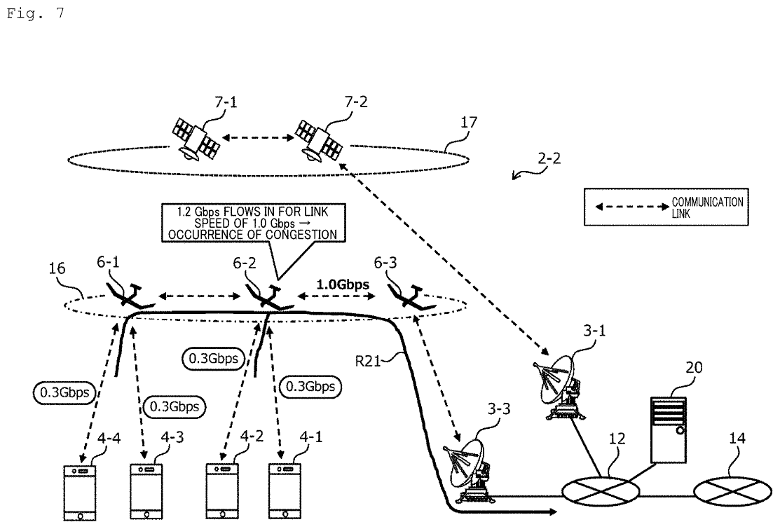

FIG. 7 shows a configuration of a wireless communication system according to a second embodiment. As shown in FIG. 7, the wireless communication system 2-2 according to the present embodiment includes a low altitude network 16 and a high altitude network 17.

HAPSs are deployed as low altitude node stations 6-1, 6-2, and 6-3 (node stations of a first group) constituting the low altitude network 16. That is, the low altitude network 16 is a HAPS network. The low altitude node station 6-1 is connected to the low altitude node station 6-2 through a communication link, and the low altitude node station 6-2 is connected to the low altitude node station 6-1 and the low altitude node station 6-3 through communication links. The low altitude node station 6-3 is connected to a ground base station 3-3 through a communication link. The low altitude network 16 is connected to a mobile network 12 via the ground base station 3-3.

LEOs are deployed as high altitude node stations 7-1 and 7-2 (node stations of a second group) constituting the high altitude network 17. That is, the high altitude network 17 is a LEO network. The high altitude node station 7-1 is connected to the high altitude node station 7-2 through a communication link. The high altitude node station 7-2 is connected to a ground base station 3-1 through a communication link. The high altitude network 17 is connected to the mobile network 12 via the ground base station 3-1. The number of node stations in each of the networks 16 and 17 shown in FIG. 7 is an example.

The high altitude network 17 and the low altitude network 16 are not connected in advance through a communication link. As will be described later, the wireless communication system 2-2 reconfigures a link between the high altitude network 17 and the low altitude network 16 in response to detection of a congestion state of any of the low altitude node stations.

The node station-mounted communication device 30 shown in FIG. 3 is mounted on the node stations 6-1 to 6-3, 7-1, and 7-2. In the third and fourth embodiments which will be described later, the node station-mounted communication device 30 shown in FIG. 3 is mounted on each node station. The configuration of the node station-mounted communication device 30 is as described in the first embodiment. The network controller 20 is connected to the mobile network 12. The configuration of the network controller 20 is the same as that shown in FIG. 4. The network controllers 20 of the third and fourth embodiments which will be described later also have the configuration shown in FIG. 4.

### 2-2. Control of Communication Path

FIG. 7 illustrates an example of a transmission path normally used in the wireless communication system 2-2. In basic settings, a low altitude route R21 is determined as a communication path such that it passes through only the low altitude network 16. In the example shown in FIG. 7, terminal stations 4-3 and 4-4 are connected to the low altitude node station 6-1, and terminal stations 4-1 and 4-2 are connected to the low altitude node station 6-2. Traffic of these terminal stations 4-1 to 4-4 is transmitted to the mobile network 12 through the low altitude route R21 and the ground base station 3-3.

However, as shown in FIG. 7, the transmission capacity of the communication link of the low altitude network 16 is 1.0 Gbs. On the other hand, the amount of traffic from each of the terminal stations 4-1 to 4-4 is 0.3 Gbps. Accordingly, the total amount of traffic in the low altitude node station 6-2 is 1.2 Gbps and thus exceeds 1.0 Gbs which is the transmission capacity of the communication link. As a result, the low altitude node station 6-2 enters a congestion state.

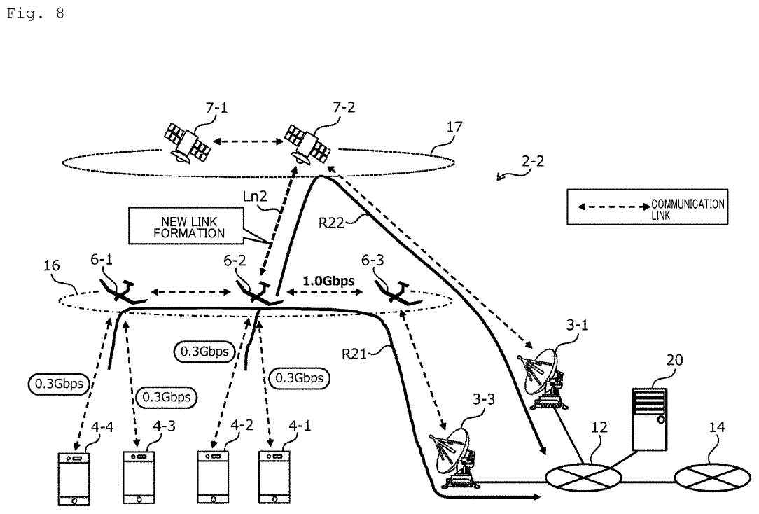

When congestion has been detected in the low altitude route R21, the wireless communication system 2-2 constructs a communication link between the low altitude node station 6-2 in a congestion state and the high altitude node station 7-2, as shown in FIG. 8. Which high altitude node station will be a connection destination of a communication link is determined from traffic observed in each high altitude node station. According to reconstruction of the communication link, a high altitude route R22 passing through the high altitude network 17 is established as a communication path from the low altitude node station 6-2 to the mobile network 12 in addition to the low altitude route R21 passing through the low altitude network 16. The high altitude route R22 is a communication path from the low altitude node station 6-2 to the ground base station 3-1 via the high altitude node station 7-2.

The wireless communication system 2-2 divides traffic flowing into the low altitude node station 6-2 into the low altitude route R21 and the high altitude route R22 and transmits the divided traffic to the mobile network 12. Accordingly, the congestion state occurring between the low altitude node station 6-2 and the low altitude node station 6-3 is canceled. However, the low altitude route R21 is a communication path with a relatively low delay, whereas the high altitude route R22 is a communication path with a relatively high delay. Accordingly, the wireless communication system 2-2 transmits only non-real-time traffic among all traffic by using the high altitude route R22 together.

### 2-3. Operations of Node Station and Network Controller

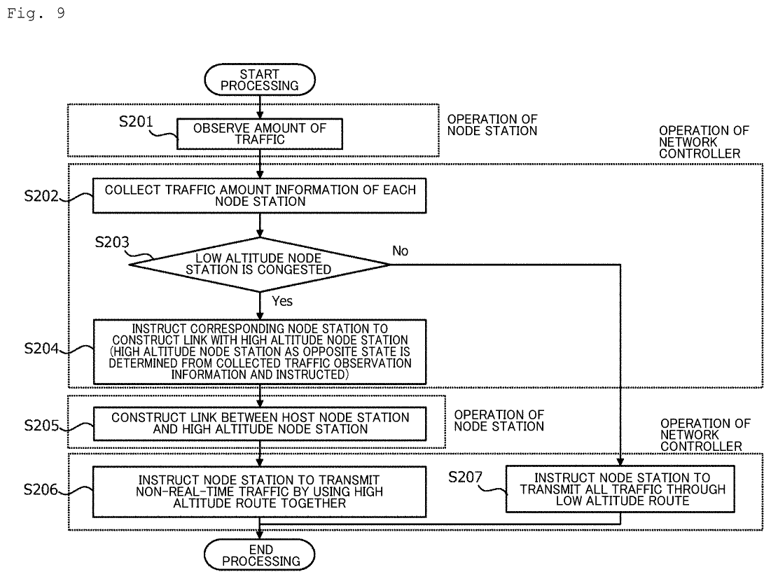

Operations of each node station and the network controller 20 in the present embodiment will be described using the flowchart of FIG. 9. The operation shown in this flowchart corresponds to a wireless communication method of the present disclosure executed by the wireless communication system 2-2.

Step S201 is the operation of each node station, more specifically, the operation executed by the node station-mounted communication device 30 having the configuration shown in FIG. 3. In step S201, the node station-mounted communication device 30 of each node station observes the amount of traffic flowing into the host device by the traffic monitor 34.

Steps S202 to S204 are operations executed by the network controller 20. In step S202, the network controller 20 collects information on the amount of traffic observed in each node station. In step S203, it is determined whether any of the low altitude node stations 6-1 to 6-3 is in a congestion state on the basis of the collected information on the amount of traffic.

If any of the low altitude node stations 6-1 to 6-3 is in a 2q9 congestion state, step S204 is selected. In step S204, the network controller 20 instructs a low altitude node station in a congestion state to construct a communication link with a designated high altitude node station. The network controller 20 determines which high altitude node station will be designated as an opposite station of the link on the basis of observation information on traffic of each of the high altitude node stations 7-1 and 7-2. In the example shown in FIG. 7, the low altitude node station instructed to construct the communication link is the low altitude node station 6-2, and the high altitude node station designated as the opposite station of the link is the high altitude node station 7-2.

Step S205 is the operation of the low altitude node station instructed from the network controller 20 in step S204. In step S205, the low altitude node station that has received the instruction constructs a communication link with the designated high altitude node station according to the instruction from the network controller 20. Accordingly, as shown in FIG. 8, a communication link connecting the low altitude node station 6-2 and the high altitude node station 7-2 is constructed, and the high altitude route R22 passing through the high altitude network 17 is established.

Steps S206 and S207 are operations executed by the network controller 20. If none of the low altitude node stations 6-1 to 6-3 is in a congestion state as a result of determination in step S203, step S207 is selected. In step S207, the network controller 20 instructs each node station to transmit all traffic through the low altitude route R21 which is a low delay communication path.

If the high altitude route R22 is established in step S205, step S206 is selected. In step S206, the network controller 20 instructs each node station to transmit only non-real-time traffic among all traffic by using the high altitude route R22 which is a high delay communication path together.

By operating each node station and the network controller 20 in accordance with the flowchart described above, the congestion state can be avoided, and the occurrence of communication delay in the NTN and reduction in the throughput of the entire system can be prevented while satisfying the QoS requirements. Although the communication path used after completion of construction of the communication link is instructed to each node station in the above-described flowchart, the communication path may be instructed in accordance with instruction of construction of the communication link.

### 3. Third Embodiment

### 3-1. Configuration of Wireless Communication System

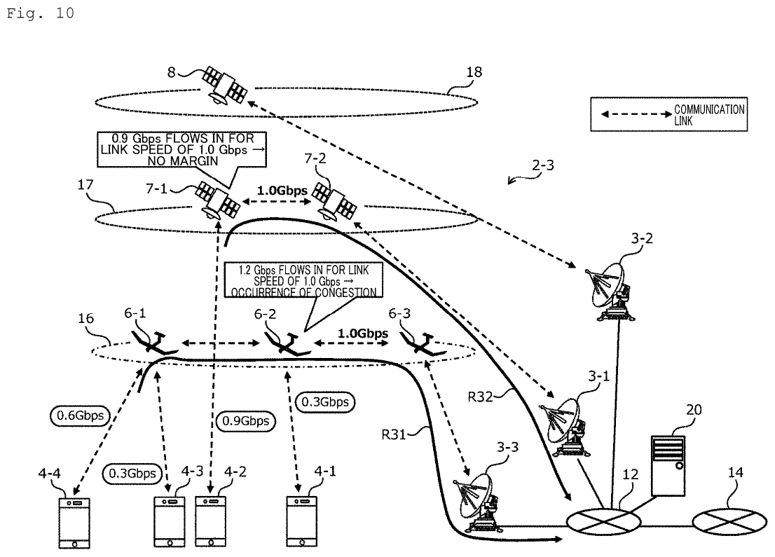

FIG. 10 shows a configuration of a wireless communication system according to a third embodiment. As shown in FIG. 10, the wireless communication system 2-3 according to the present embodiment includes a low altitude network 16, a medium altitude network 17, and a high altitude network 18.

The low altitude network 16 is an HAPS network formed by connecting HAPSs deployed as low altitude node stations 6-1, 6-2, and 6-3 through a communication link. The medium altitude network 16 is a LEO network formed by connecting LEOs deployed as medium altitude node stations 7-1 and 7-2 through a communication link. The high altitude network 18 is a GEO network formed by connecting a GEO deployed as a high altitude node station 8 through a communication link. A propagation delay increases in proportion to the altitude of each of the networks 16, 17, and 18. The number of node stations in each of the networks 16, 17 and 18 shown in FIG. 10 is an example.

The low altitude network 16 is connected to the mobile network 12 via the ground base station 3-3. The medium altitude network 17 is connected to the mobile network 12 via the ground base station 3-1. The high altitude network 18 is connected to the mobile network 12 via the ground base station 3-2. However, the three networks 16, 17 and 18 are not connected in advance by a communication link. The wireless communication system 2-3 reconstructs links between the three networks 16, 17, and 18 on the basis of a traffic state of each of the networks 16, 17, and 18.

### 3-2. Control of Communication Path

FIG. 10 shows an example of a communication path used in the wireless communication system 2-3. In the wireless communication system 2-3, a low altitude route R31 passing through the low altitude network 16 and a medium altitude route R32 passing through the medium altitude network 17 are used together as communication paths. However, there is no communication link between the low altitude network 16 and the medium altitude network 17, and the low altitude route R31 and the medium altitude route R32 are independent communication paths.

In the example shown in FIG. 10, terminal stations 4-3 and 4-4 are connected to a low altitude node station 6-1, and a terminal station 4-1 is connected to a low altitude node station 6-2. Traffic of these terminal stations 4-1, 4-3, and 4-4 is transmitted to the mobile network 12 through the low altitude route R31 and the ground base station 3-3. A terminal station 4-2 is connected to a medium altitude node station 7-1. The traffic of the terminal station 4-2 is transmitted to the mobile network 12 via the ground base station 3-1 through the medium altitude route R32.

However, as shown in FIG. 10, the transmission capacity of the communication link of the low altitude network 16 is 1.0 Gbs. On the other hand, the sum of the amounts of traffic from the terminal stations 4-1, 4-3, and 4-4 is 1.2 Gbps. Accordingly, the total amount of traffic exceeds the transmission capacity of the communication link in the low altitude node station 6-2, and the low altitude node station 6-2 enters a congestion state.

In the second embodiment, when a low altitude route is in a congestion state, a network of an upper layer is connected to a communication link. However, in the present embodiment, the amount of traffic from the terminal station 4-2 connected to the medium altitude node station 7-1 is 0.9 Gbps, which is close to 1.0 Gbs corresponding to the transmission capacity of the communication link of the medium altitude network 17. That is, the medium altitude route R32 passing through the medium altitude network 17 has no margin to accept excess traffic from the low altitude route R31.

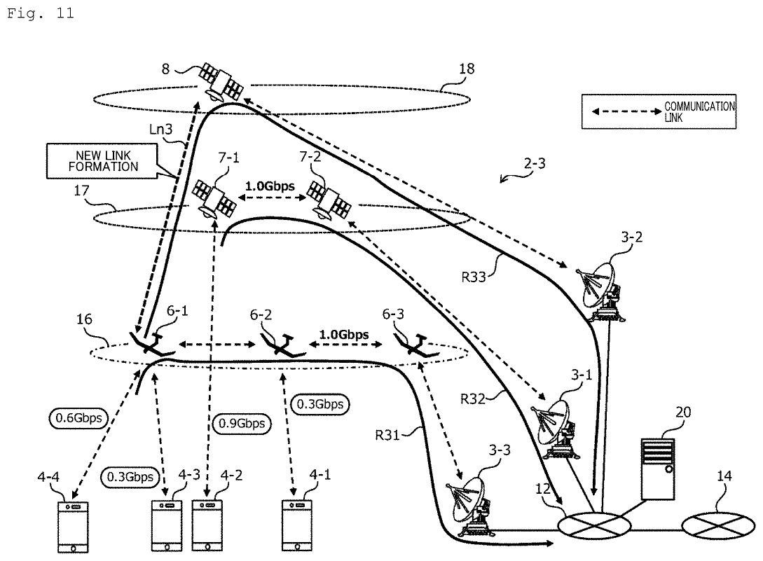

On the other hand, there is no traffic in the high altitude network 18, and the high altitude node station 8 has a margin in the amount of traffic with respect to the transmission capacity. Accordingly, when congestion has been detected in the low altitude route R31, the wireless communication system 2-3 constructs a communication link between the low altitude node station 6-1 and the high altitude node station 8, as shown in FIG. 11. According to reconstruction of the communication link, a high altitude route R33 passing through the high altitude network 18 is established as a communication path from the low altitude node station 6-1 to the mobile network 12 in addition to the low altitude route R31 passing through the low altitude network 16. The high altitude route R33 is a communication path from the low altitude node station 6-1 to the ground base station 3-2 via the high altitude node station 8.

The wireless communication system 2-3 divides traffic flowing into the low altitude node station 6-1 into the low altitude route R31 and the high altitude route R33 and transmits the divided traffic to the mobile network 12. Accordingly, the congestion state occurring between the low altitude node station 6-2 and the low altitude node station 6-3 is canceled. However, the low altitude route R31 is a communication path with a relatively low delay, whereas the high altitude route R33 is a communication path with a relatively high delay. Thus, the wireless communication system 2-3 transmits only non-real time traffic among all the traffic by using the high altitude route R33 together.

As described above, the wireless communication system and the wireless communication method according to the present embodiment can avoid a congestion state and prevent the occurrence of communication delay in the NTN and reduction in the throughput of the entire system while satisfying QoS requirements.

Although a communication link is constructed between the low altitude node station 6-1 and the high altitude node station 8 in the example shown in FIG. 11, a communication link may be constructed between the low altitude node station 6-2 in a congestion state and the high altitude node station 8.

Further, when congestion has been detected in the low altitude route R31, first, the low altitude network 16 and the medium altitude network 16 may be connected by a communication link, and excess traffic of the low altitude route R31 may be caused to flow to the medium altitude route R32. When congestion has been detected in the medium altitude route R32, the medium altitude network 16 and the high altitude network 16 may be connected by a communication link, and excess traffic of the medium altitude route R32 may be caused to flow to the high altitude route R33.

### 4. Fourth Embodiment

### 4-1. Configuration of Wireless Communication System

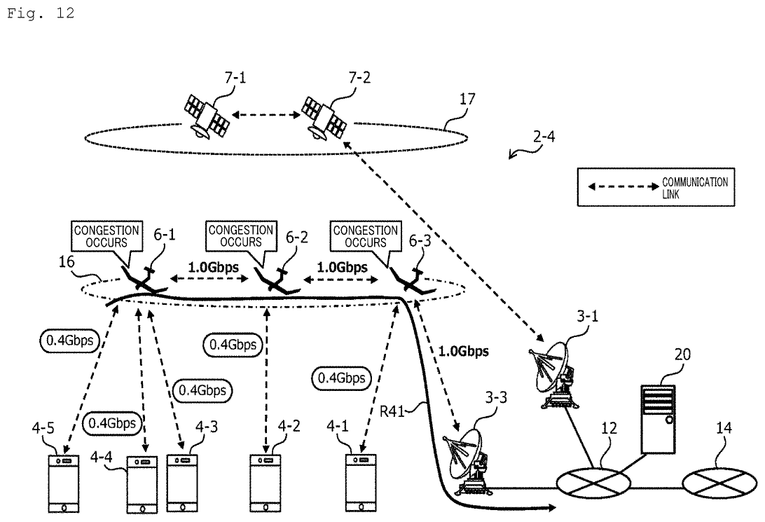

FIG. 12 shows a configuration of a wireless communication system according to a fourth embodiment. As shown in FIG. 12, the wireless communication system 2-4 according to the present embodiment has the same configuration as that of the wireless communication system 2-2 according to the second embodiment. However, there are differences in connection destinations and the amounts of traffics of the terminal stations 4-1 to 4-4. In the present embodiment, terminal stations 4-3, 4-4, and 4-5 are connected to the low altitude node station 6-1, the terminal station 4-2 is connected to the low altitude node station 6-2, and the terminal station 4-1 is connected to the low altitude node station 6-3. The transmission capacity of the communication link of the low altitude network 16 is 1.0 Gbs, while the amount of traffic from each of the terminal stations 4-1 to 4-5 is 0.4 Gbps.

### 4-2. Control of Communication Path

FIG. 12 shows an example of a communication path normally used in the wireless communication system 2-4. In basic settings, a low altitude route R41 is determined as a communication path such that it passes through only the low altitude network 16. The traffic of terminal stations 4-1 to 4-5 connected to the low altitude network 16 is transmitted to the mobile network 12 through the low altitude route R41 and the ground base station 3-3.

However, as shown in FIG. 12, the transmission capacity of the communication link of the low altitude network 16 is 1.0 Gbs. On the other hand, the amount of traffic from each of the terminal stations 4-3 to 4-5 is 0.4 Gbps. Therefore, the total amount of traffic in the low altitude node station 6-1 is 1.2 Gbps, which exceeds 1.0 Gbs corresponding to the transmission capacity of the communication link. As a result, the low altitude node station 6-1 enters a congestion state.

Further, the low altitude node station 6-2 receives traffic of 1.4 Gbs that is the sum of traffic of 1.0 Gbs corresponding to the transmission capacity of the communication link received from the low altitude node station 6-1 and traffic of 0.4 Gbs from the terminal station 4-2. However, the amount of traffic of 1.4 Gbs exceeds the transmission capacity of a communication link between the low altitude node station 6-2 and the low altitude node station 6-3. Therefore, the low altitude node station 6-2 also enters a congestion state.

Furthermore, the low altitude node station 6-3 receives traffic of 1.4 Gbs that is the sum of traffic of 1.0 Gbs corresponding to the transmission capacity of the communication link received from the low altitude node station 6-2 and traffic of 0.4 Gbs from the terminal station 4-1. However, the amount of traffic of 1.4 Gbs exceeds the transmission capacity of the communication link between the low altitude node station 6-3 and the ground base station 3-3. Therefore, the low altitude node station 6-3 also enters a congestion state.

In this way, when the transmission capacity of the communication link between the low altitude node stations is equal, the upstream low altitude node station 6-1 enters a congestion state and thus the downstream low altitude node stations 6-2 and 6-3 also enter a congestion state. Here, even if a link is constructed between the low altitude node station 6-3 and the high altitude network 17, congestion states of the low altitude node stations 6-1 and 6-2 are not canceled. Further, even if a link is constructed between the low altitude node station 6-2 and the high altitude network 17, the congestion state of the low altitude node station 6-1 is not canceled.

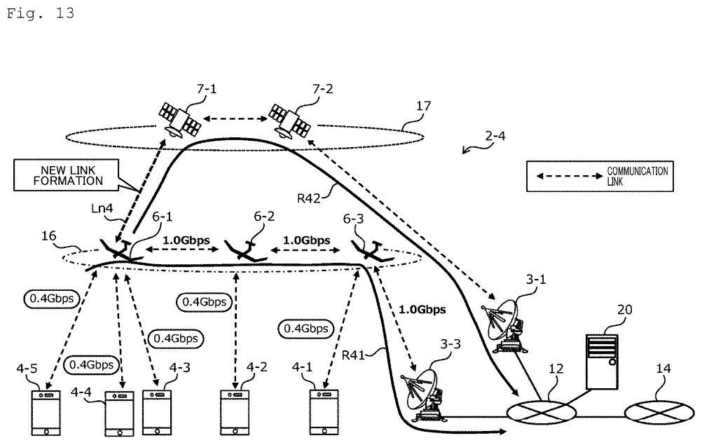

Therefore, when congestion has been detected in a plurality of low altitude node stations, the wireless communication system 2-4 constructs a communication link between the most upstream low altitude node station 6-1 in a congestion state and the high altitude node station 7-1, as shown in FIG. 13. Which high altitude node station will be a connection destination of a communication link is determined from traffic observed in each high altitude node station. According to reconstruction of the communication link, a high altitude route R42 passing through the high altitude network 17 is established as a communication path from the low altitude node station 6-1 to the mobile network 12 in addition to the low altitude route R41 passing through the low altitude network 16. The high altitude route R42 is a communication path from the low altitude node station 6-1 to the ground base station 3-1 via the high altitude node stations 7-1 and 7-2.

The wireless communication system 2-4 divides traffic flowing into the low altitude node station 6-1 into the low altitude route R41 and the high altitude route R42 and transmits the divided traffic to the mobile network 12. Accordingly, the congestion state occurring in the low altitude node station 6-1 is canceled, and further, the congestion states occurring in the downstream low altitude node stations 6-2 and 6-3 are also canceled. However, the low altitude route R41 is a communication path with a relatively low delay, whereas the high altitude route R42 is a communication path with a relatively high delay. Accordingly, the wireless communication system 2-4 transmits only non-real time traffic among all the traffic by using the high altitude route R42 together.

As described above, the wireless communication system and the wireless communication method according to the present embodiment can avoid a congestion state and prevent the occurrence of communication delay in the NTN and reduction in the throughput of the entire system while satisfying QoS requirements.

### REFERENCE SIGNS LIST

2-1, 2-2, 2-3, 2-4 Wireless communication system
4-1, 4-2, 4-3, 4-4, 4-5 Terminal station
6-1, 6-2, 6-3 Node station (HAPS)
7-1, 7-2, 7-3 Node stations (LEO)
8 Node station (GEO)
3-1, 3-2, 3-3 Ground base station
16 Network (HAPS network)
17 Network (LEO Network)
18 Network (GEO network)
12 Mobile network
20 Network controller
30 Node station-mounted communication device
R11, R21, R31, R41 Low delay communication path (low altitude route)
R12, R22, R32, R42 High delay communication path (high altitude route)

1. A wireless communication system,
comprising:
circuitry configured to:
transmit all traffic using g low delay communication path until the low delay communication path enters a congestion state; and
transmit traffic having a long allowable delay time among all the traffic by using the low delay communication path and a high delay communication path together upon receiving detection of a congestion state of the low delay communication path.

2. The wireless communication system according to claim 1, wherein:
the circuitry is further configured to reconstruct a link between g first group of node stations and g second group of node stations upon receiving detection of a congestion state of any node station in the first group of node stations.

3. The wireless communication system according to claim 2, wherein:
the circuitry is further configured to link a node station in a congestion state or a node station having a large amount of traffic in the first group of node stations to a node station having a margin in a transmission capacity in the second group of node stations.

4. The wireless communication system according to claim 3, wherein:
the circuitry is further configured to select a node station in a congestion state located at a most upstream side in the first group of node stations as a link connection destination when the plurality of node stations of the first group of node stations are in a congestion state.

5. The wireless communication system according to claim 1, wherein:
the circuity is further configured to detect a congestion state of the low delay communication path by observing any of a buffer use rate, a number of packet losses, an amount of packets waiting for transmission, and an amount of traffic flowing in within a certain period of time in each node station included in the first group of node stations.

6. A wireless communication method, comprising:
transmitting all traffic using the low delay communication path until the low delay communication path enters a congestion state; and
transmitting traffic having a long allowable delay time among all the traffic by using the low delay communication path and the high delay communication path together upon receiving detection of a congestion state of the low delay communication path.

7. A network controller,
comprising:
circuitry configured to:
establish a low delay communication path by linking node stations of a first group among the plurality;
establish a high delay communication path by linking node stations of a second group of node stations among the plurality of node stations and at least one node station of the first group of node stations;
wherein a wireless communication system using the network controller comprises circuitry configured to:
transmit all traffic using the low delay communication path until the low delay communication path enters a congestion state; and
transmit traffic having a long allowable delay time among all the traffic by using the low delay communication path and the high delay communication path together upon receiving detection of a congestion state of the low delay communication path.

8. A non-transitory computer readable medium storing a network control program comprising a program for causing a computer to execute processing performed by the network controller according to claim 7.
